(19) United States
(12) Patent Application Publication
(10) Pub. No.: US 2026/0257234 A1
(43) Pub. Date: Sep. 3, 2026

(54) DISPENSING BOTTLE FOR EFFICIENT EXTRACTION OF HIGH-VISCOSITY LIQUIDS

(71) Applicant: Shiro Ando, Reading, MA (US)

(72) Inventor: Shiro Ando, Reading, MA (US)

(21) Appl. No.: 19/067,281

(22) Filed: Feb. 28, 2025

(51) Int. Cl. B05B 11/00

(52) U.S. Cl. CPC B05B 11/0089; B05B 11/0038

(57) ABSTRACT

The present invention relates to a liquid dispensing bottle designed to optimize the flow and extraction of liquids, particularly high-viscosity substances such as lotions and shampoos. The bottle includes an outer wall extending from a bottom end to a top end, with an opening providing access to an inner cavity. An inner wall, coated with FDA-approved fluorosilicone, features gradually sloped curved portions tapering downward to form a semicircular bottom member with a central flat end. This design minimizes liquid adhesion and ensures efficient flow towards the straw. The bottle incorporates a rigid straw with triangular ends, each featuring V-shaped openings to allow liquid entry from multiple directions, thereby maximizing dispensing efficiency.

### TECHNICAL FIELD

The present disclosure relates to dispensing devices for liquids and, more particularly, to an innovative bottle design with enhanced features for optimal liquid flow. The device is effective for dispensing both thick and thin liquids, such as lotions, shampoos, and sanitizers.

### BACKGROUND OF INVENTION

The following description includes information that may be useful in understanding the present disclosure. It is not an admission that any of the information provided herein is prior art or relevant to the present disclosure, or that any publication specifically or implicitly referenced is prior art.

Dispensing bottles are widely used for storing and dispensing liquids such as sanitizers, lotions, shampoos, and other personal care or household products. Conventional dispensing bottles typically rely on a straw or dip tube to extract the contents. While the conventional design is adequate for thin liquids that flow easily, it often proves inefficient for thicker products with higher viscosity, such as lotions and shampoos.

One common feature of conventional bottles is the inclusion of a small reservoir or dip at the bottom of the bottle, designed to hold the straw or dip tube in place. While the configuration may facilitate liquid flow for thin substances, it creates significant challenges for thicker liquids. High-viscosity products often struggle to flow into the small reservoir areas due to the limited space and the surface tension of the liquid. As a result, users experience difficulty in extracting the full content of the bottle, leading to waste and frustration.

Another drawback of traditional designs is the incomplete extraction of product, particularly when the bottle is nearing empty. Due to the flat bottoms attached to inner walls of conventional bottles, the last portions of liquid can become trapped in corners or along the walls, rendering them inaccessible to the straw. Users are often forced to shake, tilt, or tap the bottle repeatedly in an attempt to dislodge the remaining contents, which can be time-consuming and inconvenient.

Current solutions to these issues, such as using squeezable bottles or wider straws, come with their own limitations. Squeezable bottles are not always practical for rigid or larger containers, and wider straws may not fit all bottle designs or may compromise the flow of thinner liquids. Moreover, conventional straws often have limited openings at the tip, restricting the liquid flow to a single direction and further reducing dispensing efficiency. When a perimeter of an end of a straw sits flush on a flat bottom, liquid may not be able to be extracted within the straw.

A need exists for an improved dispensing bottle that overcomes inherent challenges of traditional dispensing bottles and optimizes liquid flow and minimizes product waste.

### SUMMARY OF INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an aspect, the present disclosure relates to a liquid dispensing bottle designed to optimize the flow and extraction of liquids, particularly high-viscosity substances such as lotions and shampoos. The bottle comprises an outer wall extending from a bottom end to a top end, with the top end having an opening providing access to an inner cavity. Within the cavity, an inner wall extends downward and includes gradually sloped curved portions tapering inwardly to form a semicircular bottom member with a central flat end. The central flat end is configured to align with a straw, ensuring maximum liquid capture. The inner wall is smooth, free of ridges and grooves, and coated with an FDA-approved fluorosilicone material to reduce liquid adhesion, improve flow, and minimize waste.

In an exemplary embodiment, the bottle is equipped with a rigid straw featuring pointed triangular ends, each end having V-shaped openings to allow liquid to flow into the straw from multiple directions, enhancing dispensing efficiency. The straw is designed to extract at least 99% of the liquid from the container. The straw can be fabricated using extrusion techniques and has a length ranging from about 6 inches to about 10 inches, making it compatible with bottles of various sizes. The outer wall of the bottle may be constructed from metals such as glass, stainless steel, aluminum, or titanium, or from plastic or composite materials such as polyethylene, polypropylene, polycarbonate, depending on the desired application.

In an exemplary embodiment, the inner wall may have a thickness ranging from about 0.01 inches to about 0.3 inches, and the height of the curved portions may range from about 0.5 inches to about 2 inches. The central flat end of the inner wall is designed to have a width substantially equal to the diameter of the straw to ensure alignment and efficient liquid capture. The manufacturing process for the bottle may include injection moulding or blow moulding, with the fluorosilicone coating applied through dip coating, spray coating, or spin coating methods to create a smooth, low-friction surface.

The invention also contemplates alternative embodiments for bottles of different shapes, such as cylindrical containers, where the curved portions of the inner wall taper downward to a flat bottom portion. Branding or indicia can be added to the outer wall for marketing purposes. The disclosed liquid dispensing bottle provides an innovative solution for maximizing the usability of both thick and thin liquids, minimizing waste, and enhancing user convenience.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

FIG. 1 illustrates a perspective view of one embodiment of a liquid dispensing bottle 100 of the present invention;

FIG. 2 illustrates a perspective view of the triangular end straw used with the liquid dispensing bottle 100 of the present invention;

FIG. 3 illustrates a perspective of another embodiment of the liquid dispensing bottle in accordance with the disclosed structure; and

FIG. 4 illustrates a perspective view of the bottle of FIG. 3 used with the triangular end straw in accordance with one embodiment of the present invention.

FIG. 5 is a bottom perspective view of the bottle of FIG. 4.

FIG. 6 is a dispensing bottle having a rectangular shape.

FIG. 7 is another view of a dispensing bottle according to another embodiment.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises… a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

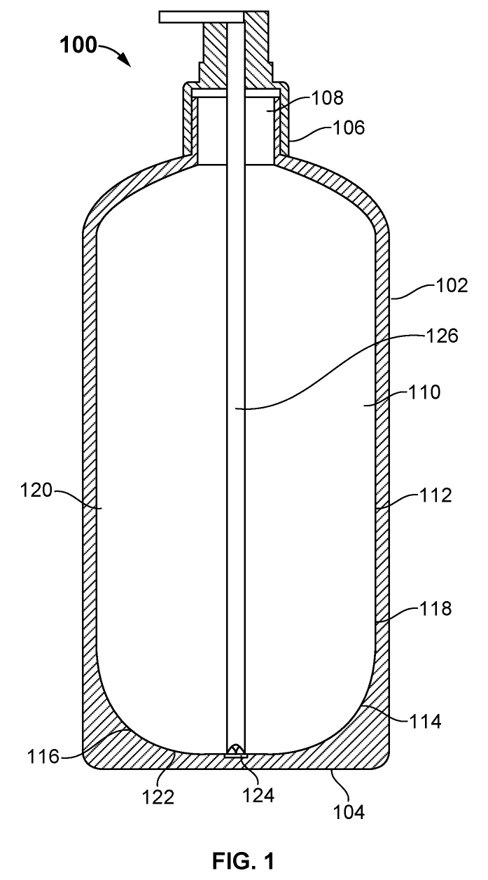

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIGS. 1-7.

Although the majority of the figure drawings depict a liquid dispensing bottle 100 designed primarily for personal care products such as lotions, shampoos, and sanitizers, the present disclosure contemplates adaptations for a broader range of liquids and applications. While the bottle is detailed here in its most common use as a personal care product dispenser, it is envisioned that variations or modified configurations could be employed for other types of liquids, such as food products (e.g., honey, syrups, or dressings), industrial lubricants, or medical supplies. These alternative implementations may retain the same or similar structural components and features, such as the rigid, V-shaped straw, fluorosilicone-coated interior walls, and elimination of a small reservoir area, as described herein, while being adapted for specific use cases.

FIG. 1 illustrates a perspective view of one embodiment of a liquid dispensing bottle 100 of the present invention. The liquid dispensing bottle 100 is designed for optimizing the flow and usability of various liquids, particularly thicker ones like lotions and shampoos. The bottle or container 100 includes an outer wall 102 having a thickness which forms the outer shell of the container 100 and the outer wall 102 extends from a bottom end 104 to an opposite top end 106. An opening 108 is disposed at the top end 106 and is configured to provide access to a cavity 110 of the bottle 100 via a dispensing pump (not shown).

An inner wall 112 of the bottle 100 extends from the top end 106 and has opposite gradually sloped curved portions 114, 116 tapering downward and inward from the longitudinal portions 118, 120 respectively. The curved portions 114, 116 form a semicircular bottom member 122 of the inner wall 112 wherein the bottom member 122 has a central flat platform 124. Preferably, the central flat platform 124 has a diameter equal to or just greater than a diameter of a straw implemented in this embodiment.

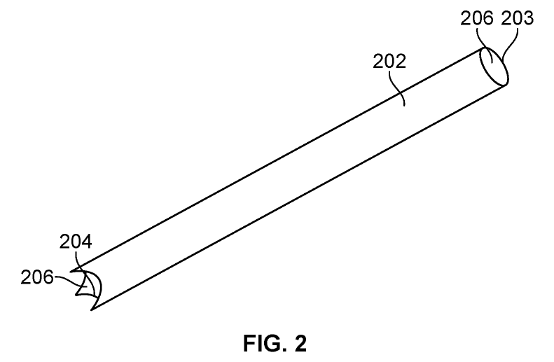

Liquid stored in the bottle 100 easily flows through the curved portions 114,116 towards the central flat platform 124 and can be captured by the straw 126. It should be noted that any conventional straw can be used with the bottle 100, however, preferably, a straw with a plurality of triangular ends as illustrated in FIG. 2 is used with the bottle 100 for capturing about, or as close to 100% as possible of the liquid from the bottle 100. The inner wall 112 is smooth and does not have ridges or grooves and may be coated with a food grade material such as FDA-approved Fluorosilicone coatings.

The outer wall 102 may be fabricated from one or more metals, including, but not limited to, stainless steel, aluminum, and/or titanium and alloys thereof. The inner wall 112 may be fabricated from a plastic, such as polyethylene, polypropylene, polycarbonate or composite material or a combination of metals and alloys thereof, plastics, and/or composite materials. The inner wall 112 may have a thickness of about 0.01 inches or a thickness in the range of about 0.005 inches to about 0.02 inches, or a thickness in the range of about 0.015 in to about 0.3 inches. The height of the curved portions 114,116 may be about 1 inch, or may be in the range of about 0.5 inches to about 3 inches.

FIG. 2 illustrates a perspective view of the triangular end straw used with the liquid dispensing bottle 100 of the present invention. As illustrated, the straw 202 has a pointed end 206, and an opposing end 203 connected to a dispensing pump (not shown).

Each pointed end is configured to reach the central flat platform 124. The pointed ends 206 incorporate a plurality of V-shaped openings 206, allowing the liquid from the flat platform 124 to flow into the straw 202, enhancing dispensing efficiency. The straw 202 can have a length from about 6 inches to about 10 inches to be compatible with bottles of different sizes. The size of the straw is relational to the height of a given bottle.

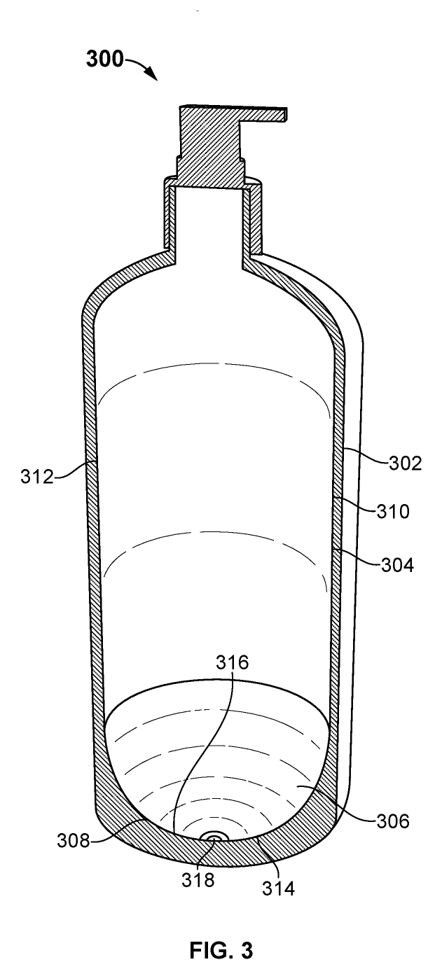

FIG. 3 illustrates a perspective of another embodiment of the liquid dispensing bottle in accordance with the disclosed structure. In the present embodiment, the outer wall 302 of the bottle 300 is cylindrical and extends below the inner wall 304 of the bottle 300. The inner wall 304 has gradually sloped curved portions 306, 308 tapering downward and inward from the longitudinal portions 310, 312 respectively. The bottom end 314 of the bottle 300 has the only flat platform 318 at an inside bottom end of bottle 300, which helps the straw of FIG. 2 to capture the liquid from the bottle 300. Having a platform 318 with a diameter just larger than a diameter of the straw end further serves to collect all of the liquid to a small area accessible by the straw in a stationary position.

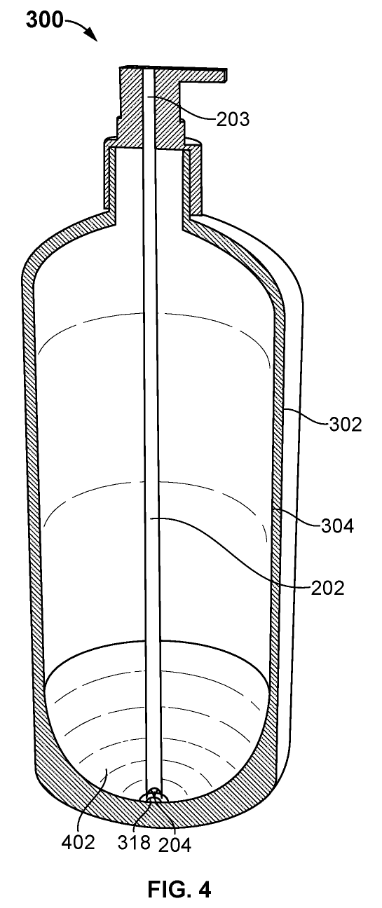

FIG. 4 illustrates a perspective view of the bottle 300 of FIG. 3 used with the triangular cut end 204 in accordance with one embodiment of the present invention. As illustrated, the straw 202 is placed inside the bottle 300 and the pointed end 206 rests on the flat portion 318 allowing a user to capture liquid 402 from the bottle 300 through openings 204 of the straw.

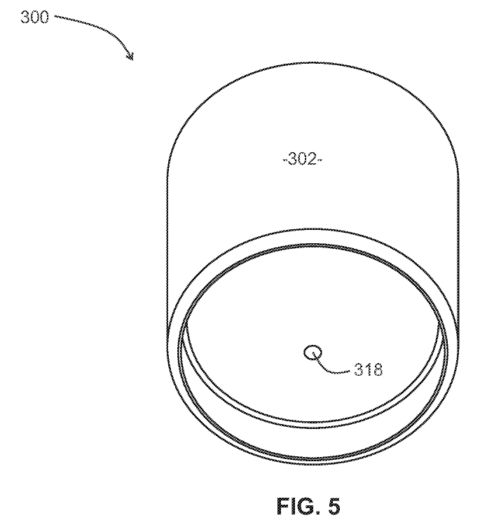

FIG. 5 is a bottom perspective view of the bottle of FIG. 4. In this perspective a curved bottom with a flat platform 318 is centered at a centered lower portion of the curved bottom. Outer wall 302 is shown extending below the inner wall 304 forming the lower sloping curve of the bottle.

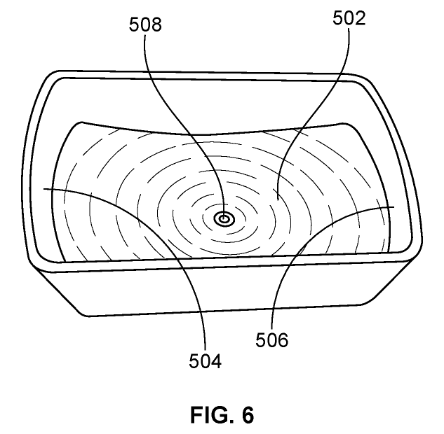

FIG. 6 is a bottom inside view from a dispensing bottle having a rectangular shape. In this embodiment, inner wall 504 may have opposing, somewhat planar walls extending to a lower portion, where a curved bottom portion 502 starts at a designated point 506. The curved portion 502 assists liquid to translate to flat platform 508 centered within the curved portion 502. A pointed end of the straw directly contacts the platform with all three points of the straw show in FIG. 2.

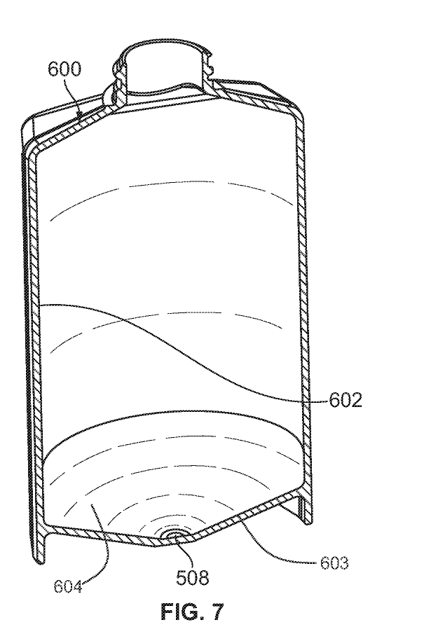

FIG. 7 is a longitudinal cut view of the inside of a curved lower portion and bottom of a dispensing bottle having a barrel shape. In this embodiment, an outside wall 600 extends below an inner wall 602 extending down to a bottom portion 603 having a straight slope circular cone 604 forming the bottom. Flat platform 508 is centered at the cone portion 604 engaging a pointed end of the straw for extracting liquids of various types. Depending on the type of liquid and viscosity, one liquid may translate easier to the platform 508 with the flat slope 603 forming cone 604, than another liquid.

The bottle of different embodiments can be made using injection moulding wherein plastic granules are melted and injected into a mold that defines the shape of the bottle or its parts. In some embodiments, blow moulding can be used including any one of extrusion blow moulding, injection blow moulding, and stretch blow moulding.

For coating the inner wall of the bottle with FDA-approved fluorosilicone, the bottle may be dipped into a fluorosilicone solution, then cured to form a smooth, thin coating. Alternatively, spray coating or spin coating can also be used for applying FDA-approved fluorosilicone. The coating helps reduce adhesion of liquids to the walls, smooths the flow and minimizes product waste left in the bottle. The straw is integrated into the bottle during use and a logo or indicia can be added to the bottle for branding and marketing purposes.

A description of an embodiment with several components in communication with each other does not imply that all such components are required. On the contrary, a variety of optional components are described to illustrate the wide variety of possible embodiments of the disclosure. Further, there are other components also present in the substation communication network, however, these are not presented in the description to focus on the main features of the invention.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A liquid dispensing bottle, comprising:
an outer wall extending from a bottom end to an opposite top end;
an inner wall extending from the top end and having opposite gradually sloped curved portions tapering downward and inward from longitudinal portions, the curved portions forming a semicircular bottom member;
the bottom member comprising a central flat end configured to align with a straw for capturing liquid; and
a straw with at least one triangular end, the triangular end comprising a plurality of V-shaped openings to allow liquid to flow into the straw from multiple directions.

2. The liquid dispensing bottle of claim 1, wherein the outer wall is fabricated from glass, polyethylene, polypropylene, polycarbonate, stainless steel, aluminum, or titanium.

3. The liquid dispensing bottle of claim 1, wherein the straw has a length in the range of about 6 inches to about 10 inches.

4. The liquid dispensing bottle of claim 1, wherein the central flat end of the inner wall has a width substantially equal to the diameter of the straw.

5. A liquid dispensing system for high-viscosity liquids, comprising:
a container having an outer wall made from metal or plastic and extending from a bottom end to a top end, the top end having an opening providing access to an inner cavity;
an inner wall within the container, the inner wall having curved portions tapering inwardly and downwardly to form a central flat end at the bottom of the cavity; and
an integrated straw with pointed triangular ends configured to reach the central flat end, the triangular ends having V-shaped openings to enhance liquid flow into the straw, wherein the straw is configured to extract at least 99% of the liquid from the container.

6. The liquid dispensing system of claim 5, wherein the inner wall is coated with fluorosilicone for reducing liquid adhesion and optimizing flow.

7. The liquid dispensing system of claim 5, wherein the container is cylindrical and the curved portions of the inner wall have a height in the range of about 0.5 inches to about 2 inches.

8. A method of manufacturing a liquid dispensing bottle with enhanced flow efficiency, comprising:
fabricating an outer wall of a container using injection moulding or blow moulding;
forming an inner wall within the container, the inner wall comprising gradually sloped curved portions tapering downward and inward to form a semicircular bottom member with a central flat end;
applying an FDA-approved fluorosilicone coating to the inner wall by dip coating, spray coating, or spin coating to create a smooth, low-friction surface;
fabricating a straw with opposite triangular ends and a plurality of V-shaped openings for optimized liquid flow; and
integrating the straw into the container such that one triangular end aligns with the central flat end of the inner wall.
